(19) United States
(12) Patent Application Publication
(10) Pub. No.: US 2025/0023281 A1
(43) Pub. Date: Jan. 16, 2025

(54) PLUG-IN CONNECTION WITH REMOVABLE PIN CONTACT OR SOCKET CONTACT

(71) Applicant: HIRSCHMANN AUTOMOTIVE GMBH, Rankweil/Brederis (AT)

(72) Inventors: Michael ORWAT, Eriskirch (DE); Jens HELD, Rötha (DE)

(73) Assignee: HIRSCHMANN AUTOMOTIVE GMBH, Rankweil/Brederis (AT)

(21) Appl. No.: 18/710,882

(22) PCT Filed: Oct. 18, 2022
(86) PCT No.: PCT/EP2022/078973

§ 371 Date: May 16, 2024

(30) Foreign Application Priority Data
Dec. 17, 2021 (DE) 10 2021 133 646.5

(51) Int. Cl. H01R 13/422

(52) U.S. Cl. CPC H01R 13/422

(57) ABSTRACT

Plug-in connection with at least one pin contact (1) and/or with at least one socket contact that are connected to a cable and that communicate with a pin contact (3) or socket contact, wherein the pin contact (3) or the socket contact can be installed in a plug housing (1) engagement, characterized in that the engaged state can be non-destructively released.

The invention relates to a plug-in connection with at least one pin contact and/or with at least one socket contact, which are connected to a cable and are in connection with a pin or socket housing, wherein the pin or socket housing can be installed in a plug housing by means of engagement, in accordance with the features of the preamble of claim 1.

Such a plug-in connection is known from DE 10 2011 051 291 A1. In this plug-in connection, which is constructed in several parts, the angularly designed pin housing or socket housing is fixed by means of latching arms arranged on an intermediate housing, whereby the pin housing or socket housing is permanently connected to the intermediate housing. The disadvantage of this engagement is that the pin or socket housing is so firmly connected to the intermediate housing that it cannot be removed without destroying it.

The object of the invention is to improve a plug-in connection in such a manner that the pin or socket housing can be easily removed again despite good fixation of the same in an adjacent component.

According to the invention, the object is achieved by the engagement being designed to be non-destructively detachable. This means that the pin or socket housing can be easily exchanged and replaced with another or even a different type of housing.

Preferably, the pin or socket housing is designed to be substantially cylindrical, at least in the installation area of the plug housing and the installation area of the plug housing.

The pin or socket housing has a locking ring and the installation area of the plug housing has at least one locking hook, which is arranged to be elastically flexible. The pin or socket housing can be inserted into the installation area of the connector housing and fixed to the locking ring by means of the locking hook(s) in the installed state. It should be expressly indicated that instead of the arrangement of the locking ring on the pin or socket housing and the fastening of the locking hook or hooks in the installation area of the plug housing, the locking hooks can also be arranged on the pin or socket housing, wherein the locking ring can then be provided as an annular cut-out in the installation area of the plug housing.

The locking hook(s) further have extension lugs protruding from the pin or socket housing, wherein the installation area of the plug housing may have an annular extension that extends from the end of the plug housing to the locking hooks. Preferably, however, recesses are incorporated in the installation area of the plug housing in which the locking hooks with the extension lugs are installed. Individual extensions are also provided in the recesses from the locking hooks to the end of the installation area.

In a further embodiment of the invention, an unlocking tool is associated with the plug-in connection, the dimensions of which are designed to fit into the extension or extensions in the installation area. The unlocking tool has at least one wedge-shaped bevel at its end that can be inserted into the connector housing, which can contact the extension lug(s) after insertion of the unlocking tool into the connector housing and release or lift the locking hook(s) from the locking ring. The at least one wedge-shaped slope can, for example, be designed as a truncated cone.

However, it is further proposed that three locking hooks with three extension lugs are provided distributed around the circumference of the installation area, which are layered in three recesses, and that the unlocking tool has a corresponding number of arms with bevels at the insertable end to fit the extensions.

This makes it easy to unhook the pin or socket housing from the plug housing by simple means.

In further embodiments of the invention, reference is made to the drawings, in which an exemplary embodiment of the invention is shown in simplified form.

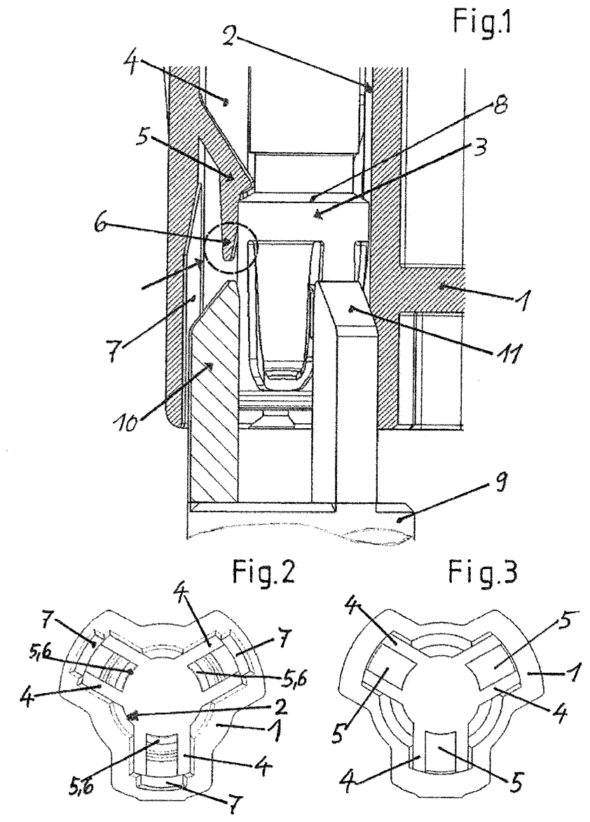

FIG. 1: shows partial sections through a plug housing and an installed socket housing and a partial section through an unlocking tool,

FIG. 2: shows a view of the connector housing with a view of the locking opening,

FIG. 3: shows a view of the connector housing with a view of the insertion opening,

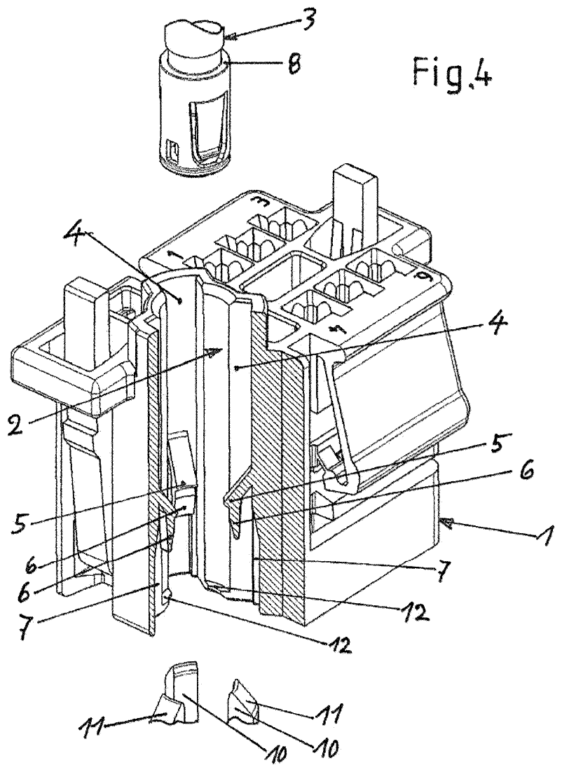

FIG. 4: shows a modified partial section through the plug housing with partial views of the socket housing and the unlocking tool and

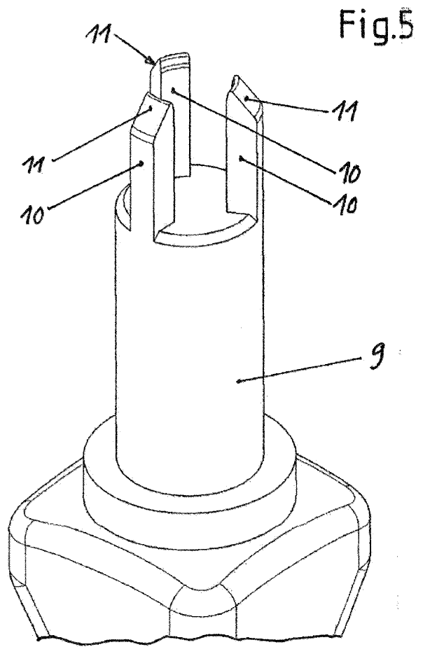

FIG. 5: shows a partial perspective view of the unlocking tool.

In FIGS. 1 to 5, where represented in detail, the reference number 1 indicates a connector housing which has a plurality of installation areas for various types of contacts, particularly pin contacts. Alternatively, it can also be a socket housing. In this case, corresponding socket contacts are arranged in the socket housing. The reference number 2 designates the installation area in the plug housing 1 which is designed for the installation of a pin or socket housing, wherein a pin contact shown here as an example is designated 3. The installation area 2 is substantially cylindrical and has three recesses labeled 4, which are arranged along the installation area 2. The recesses 4 each have a locking hook labeled 5, which protrude in the direction of the center of the installation area 2. The locking hooks 5 have extension lugs labeled 6, which are aligned in the direction of the outer circumference of the installation area 2. Between the locking hooks 5 or extension lugs 6 and the end of the plug housing 1, extensions labeled 7 are incorporated in the recesses 4. Furthermore, noses 12 protrude at the end of the installation area 2 of the cylindrical design, which limit the insertion path of the pin contact 3 or a pin contact. As can be seen in particular in FIGS. 1 and 4, a contact locking area, in particular a locking ring 8, is incorporated on the pin contact 3, on which, as can be seen in particular in FIG. 1, the locking hooks 5 engage after the pin contact 3 has been pushed into the recess 2, so that the pin contact 3 or a socket contact is fixed in both directions in the installation area 2.

In the locked or hooked state of the locking hooks 5 on the locking ring 8, the extension lugs 6 protrude slightly from the circumference of the pin contact 3, as can be seen in FIG. 1.

The reference number 9 also designates an unlocking tool which, corresponding to the number of locking hooks 5 and extension lugs 6, has projecting arms 10, at the ends of which bevels 11 are machined, the cutting edges of which are adjacent to the contact locking area, particularly the locking ring 8.

If, as indicated in FIG. 1, the unlocking tool 9 is now inserted with the arms 10 and the bevels 11 into the extensions 7 of the recesses 4, the locking hooks 5 are displaced outwards into the recesses 4 via the extension lugs 6, so that the pin contact 3 can be released from the locking mechanism and removed from the connector housing 1. To better adapt the arms 10 and the extension lugs 6 to the circumference of the pin contact 3, the inner walls of the arms 10 and the extension lugs 6 and, if necessary, the locking hook 5 are designed in the shape of a cylindrical shell, adapted to the circumference of the pin contact 3 or the locking ring 8.

### LIST OF REFERENCE SIGNS

1 Plug housing (alternatively socket housing)
2 Installation area
3 Pin contact (alternatively socket contact)
4 Recesses
5 Locking hook
6 Extension lugs
7 Extensions
8 Contact locking area (particularly locking ring)
9 Unlocking tool
10 Arms
11 Bevels
12 Noses

1.-9. (canceled)

10. A plug-in connection with at least one pin contact and/or with at least one socket contact, which are connected to a cable and are in connection with a pin or socket housing, wherein the pin contact or the socket contact can be installed in the plug housing by means of an engagement, wherein the engagement is designed to be detachable in a non-destructive manner.

11. The plug-in connection according to claim 10, wherein the pin contact or the socket contact is substantially cylindrical at least in the installation area of the plug housing and the installation area of the plug housing is substantially cylindrical.

12. The plug-in connection according to claim 10, wherein the pin contact or the socket contact has a contact locking area, particularly a locking ring which can be contacted with at least one locking hook arranged in an elastically resilient manner in the installation area of the plug housing.

13. The plug-in connection according to claim 10, wherein the locking hook(s) have protruding extension lugs from the plug housing or from the socket housing.

14. The plug-in connection according to claim 10, wherein the locking hook(s) and extension lugs are arranged in recesses which are incorporated along the installation area of the plug housing.

15. The plug-in connection according to claim 10, wherein extensions are provided in the recesses of the plug housing, which extensions extend from the end of the plug housing to the locking hooks.

16. The plug-in connection according to claim 10, wherein the plug-in connection is assigned at least one unlocking tool which has arms adapted to the extensions, wherein wedge-shaped bevels are attached to the end of the arms, which release the locking hook(s) from the locking ring when the extension lug(s) make contact.

17. The plug-in connection according to claim 10, wherein three locking hooks with extension lugs and corresponding recesses and extensions are provided distributed over the circumference of the installation area, and in that the unlocking tool has a corresponding number of arms with bevels.

18. The plug-in connection according to claim 10, wherein the mutually facing walls of the arms and/or the extension lugs and/or the locking hooks form circumferential sections of a cylinder.
